(19) United States
(12) Patent Application Publication
(10) Pub. No.: US 2026/0321473 A1
(43) Pub. Date: Oct. 15, 2026

(54) ELECTROMAGNET COIL ASSEMBLY

(71) Applicant: VDL ENABLING TECHNOLOGIES GROUP EINDHOVEN B.V., EINDHOVEN (NL)

(72) Inventors: Matthijs Wouter Marc NEUT, EINDHOVEN (NL); Jorrit Fedde BLOEMHOF, EINDHOVEN (NL)

(21) Appl. No.: 19/707,996

(22) Filed: Jun. 15, 2026

Related U.S. Application Data
(63) Continuation of application No. 17/922,517, filed on Apr. 30, 2021.

(30) Foreign Application Priority Data
May 1, 2020 (NL) 2025477

(51) Int. Cl. H01F 6/06; H01F 41/04

(52) U.S. Cl. CPC H01F 6/06; H01F 41/048

(57) ABSTRACT

An electromagnet coil assembly includes a core, a winding constituting the coil being wound in a plurality of turns around said core, and multiple power taps for electrically connecting the winding to an external power circuit. The winding is formed as a tape element including a high-temperature superconducting, HTS, material. The multiple power taps are connected to the HTS tape winding exiting the plane of the coil at an angle. The plurality of turns of the coil consists of N turns with a first power tap electrically connected with the first turn of the winding and a second power tap electrically connected with turn M of the winding, with M<N.

### CROSS-REFERENCE TO RELATED APPLICATIONS

This application is continuation of U.S. patent application Ser. No. 17/922,517, filed on Oct. 31, 2022, which is a U.S. National Stage of International Patent Application PCT/NL2021/050285, filed Apr. 30, 2021, which claims benefit of priority from Dutch Patent Application NL 2025477, filed May 1, 2020, the contents of both of which are incorporated herein by reference.

### BACKGROUND OF THE INVENTION

The invention relates to an electromagnet coil assembly in particular an electromagnet coil assembly at least comprising a core; a winding constituting the coil being wound in a plurality of turns around said core; and multiple power taps for electrically connecting the winding to an external power circuit.

An electromagnet coil assembly as described above is for example disclosed in JP 2008-305861.

### DESCRIPTION OF THE INVENTION

In general, superconductive coils are widely used for commercial and research purposes in a medical field such as NMR and MRI and an industrial field such as superconductive rotary machines (motors or generators). On the other hand, cables fabricated from high temperature superconducting (HTS) wires are known in the art and are capable of transmitting up to 10 times more current than conventional cables. Alternatively, HTS cables are also capable of carrying an equivalent amount of current at much lower voltages. HTS cables can be used in both direct current (DC) and alternating current (AC) systems. In general, high-temperature superconducting materials (abbreviated high-Tc or HTS) are operatively defined as materials that behave as superconductors at temperatures above nearly −200° C. (73, 15 K), in particular around −196.5° C. (=77 K) being the boiling point of nitrogen N₂.

As the field of high-temperature superconductivity is so new, the state of the art is a rapidly changing arena. Most electromagnetic coils implementing HTS materials are wound for academic purposes, which are generally hand-wound. Any coil needs power leads or power taps of some sort. However, in academics applications, coils are usually “one-offs” and not much time is invested in the manufacturability on a large scale and quantity basis.

It is thus an object of the present invention to provide an electromagnet coil assembly implementing HTS materials, which coil assembly can be mass-manufactured in a reliable, robust and cost-effective manner.

Accordingly, an electromagnet coil assembly is proposed comprising a core; a winding constituting the coil being wound in a plurality of turns around said core; and multiple power taps for electrically connecting the winding to at least an external power circuit, wherein said winding is being formed as a tape element comprising a high-temperature superconducting, HTS, material; and the multiple power taps are connected to the HTS tape winding exiting the plane of the coil at an angle.

Usually, the power taps of known coils are connected with the winding using soldered connections to copper busbars. When the winding is formed as a tape element comprising a high-temperature superconducting, HTS, material and by connecting the multiple power taps to the HTS tape winding thereby exiting the plane of the coil at an angle, a robust and reliable electrical connection of the coil with for example the external power source is obtained.

In particular also the power taps are made from a superconducting material, further enhancing the electromagnetic properties of the HTS coil. More in particular the power taps are formed as tape shaped power taps comprising a high-temperature superconducting, HTS, material. Specifically, the tape shaped power taps are made from the same HTS tape element as the winding.

In an example the power taps are connected to the HTS tape winding at an angle α between 30°-90°, in particular at an angle α of 90°. This enlarges the contact surface between the HTS tape winding and the tape shaped power taps.

In yet another advantageous embodiment, the power taps—seen from their position exiting the plane of the coil till their connection to a power terminal of the external power circuit—exhibit a curvature which curvature coincides with a field line of the magnetic field generated by the electromagnet coil assembly during operation. Herewith the exposure of the power taps to the magnetic field being generated creates a minimal disturbance and minimal exposure to electromagnetic (Lorentz) forces.

In a further embodiment of the HTS coil, said plurality of turns of said coil consists of N turns with a first power tap electrically connected with the first turn of the winding and a second power tap electrically connected with turn M of the winding, with M<N. In particular said first and second power taps are used to electrically connect the coil with an external power source.

In yet another embodiment of the HTS coil, the electromagnetic coil assembly further comprises multiple voltage taps for measuring a voltage across at least part of said plurality of turns of the winding, a first voltage tap is electrically connected with turn M+1 of the winding and a second voltage tap of said second type is electrically connected with turn O of the winding, with O≈N, in particular O═N. This allows for electrically connecting the first and second voltage taps to another type of peripheral equipment, more in particular to a quench detection or protection system and this allows for detecting a voltage difference between turn M+1 and turn O of the winding, which voltage difference being induced by an external disturbance of the magnetic field of the electromagnetic coil assembly.

The electromagnetic coil assembly implementing a HTS tape winding is further characterized by a specific winding principle, with the winding conforming:

$$\frac{( N - M )}{N} « 1.$$

In a specific embodiment the winding principle conforms to:

$$0.01 « \frac{( N - M )}{N} « 0.1 .$$

As in yet another example the average winding tension of the turns 1 till M of said plurality of turns is lower than the average winding tension of the turns M+1 till N of said plurality of turns, it further improves the performance of the HTS coil assembly. In particular, when the turns M+1 till N are applied with an average winding tension higher than the average higher winding tension of the turns 1 till M, the inner section of [1 . . . . M] turns of the winding are mechanically confined by the outer section of [M+1 . . . . N] turns of the winding, also improving the mechanical stability of the coil.

In an example of the HTS coil assembly the core is a ferromagnetic core, whereas in another advantageous example the core is a non-ferromagnetic core.

In a further advantageous example at least each power tap comprises multiple sub-taps, enhancing the electric connectivity of the HTS coil assembly with external peripheral equipment, in particular decreasing the contact resistance between the individual sub-taps and the HTS tape winding.

Advantageously, the HTS material is at least one of the materials from the group consisting of (RE)BCO, BSCCO, TBCCO.

### BRIEF DESCRIPTION OF THE DRAWINGS

The invention will now be discussed with reference to the drawings, which show in:

FIG. 1a-1b a first embodiment of an electromagnet coil assembly according to the invention;

FIG. 2a-2c a second embodiment of an electromagnet coil assembly according to the invention; and

FIG. 3 a detail of the second embodiment of FIG. 2.

For a proper understanding of the invention, in the detailed description below corresponding elements or parts of the invention will be denoted with identical reference numerals in the drawings.

### DETAILED DESCRIPTION OF THE DRAWINGS

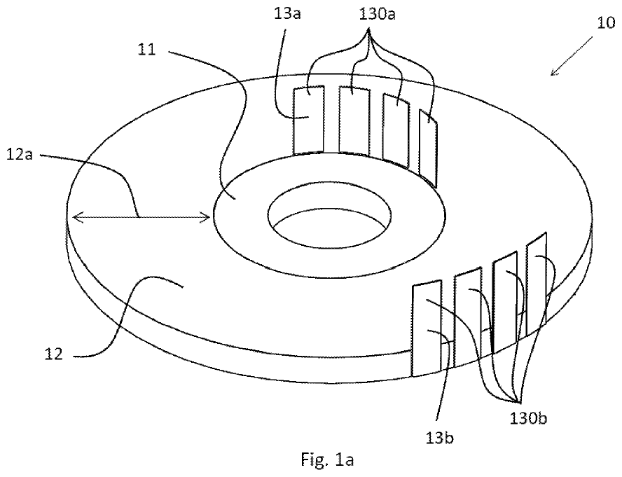

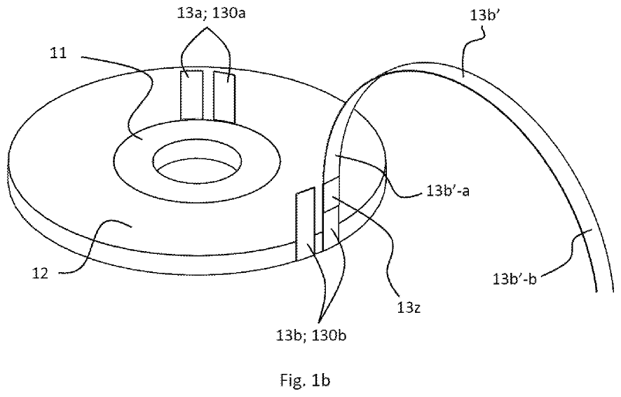

FIG. 1a-1b shows a first embodiment of an electromagnet coil assembly according to the invention. The electromagnet coil assembly is depicted with reference numeral 10 and comprises a core 11 and a winding 12. The winding 12 constitutes the coil being wound in a plurality of turns around the core 11. Preferably, the core 11 is a ferromagnetic core, however also other materials for the core 11 can be used, such as a non-ferromagnetic material.

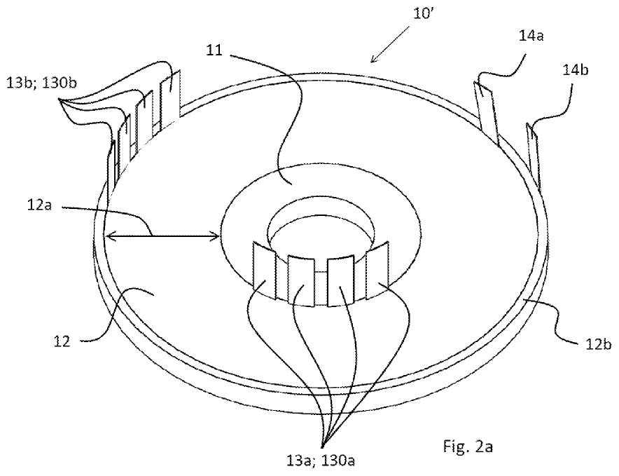

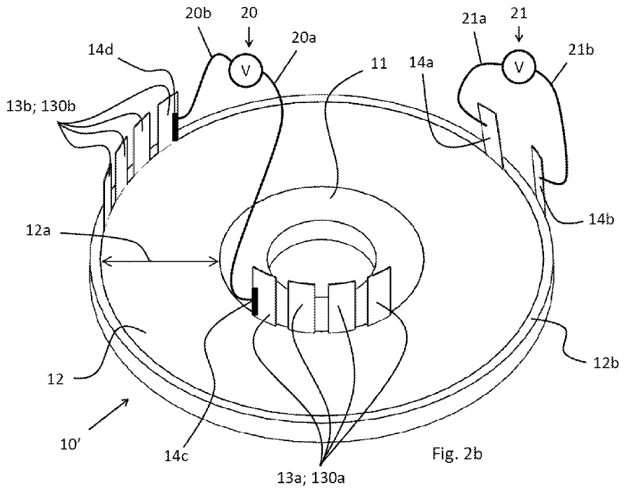

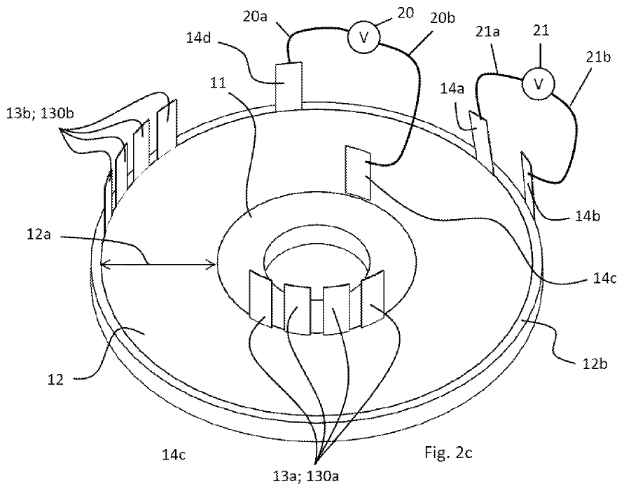

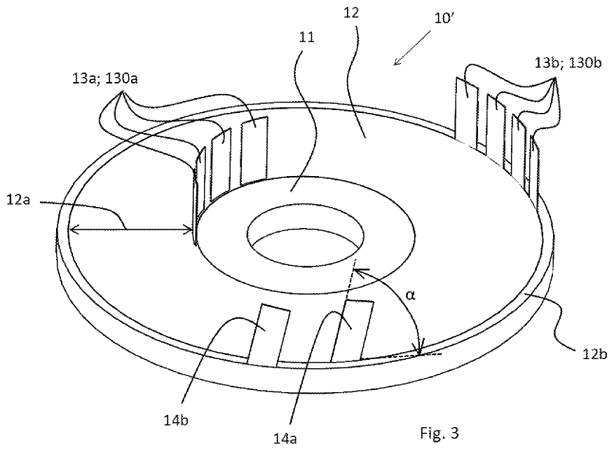

Usually, a coil assembly also comprises multiple power taps for electrically connecting the winding 12 to an external peripheral equipment, in particular to an external power source. With reference to that, reference numerals 13a and 13b depict first and second power taps for electrically connecting the winding 12 and in particular a first section 12a of the winding 12, with an external power source. The first 13a and second 13b taps are thus also denoted as first and second power taps, with the first taps 13a being the POSITIVE-terminal (+) and the tap 13b being the NEGATIVE-terminal (−). FIG. 2a and in particular FIG. 3 shown another embodiment of the electromagnetic coil assembly, indicated with reference numeral 10′, having additional taps being electrically connected with the HTS winding 12. These additional taps are denoted as first and second voltage taps (reference numerals 14a and 14b) serve to electrically connect the winding 12 to another type of external peripheral equipment, preferably a voltage detector 21 as explained later in the description.

Each power tap 13a-13b and voltage taps 14a-14b may comprise multiple sub-taps 130a130b and 140a-140b improving reliability and connectivity.

A quench protection or detection circuit connected at the voltage taps 14a-14b of the second winding section 12b of the winding 12 is essential to most coil applications, as a large amount of energy can be stored in a superconducting coil assembly. In the event of the coil losing its superconducting properties, while hundreds of amperes are running through the winding 12 of the coil assembly, it could result in a “meltdown” scenario which is a catastrophic failure of the system. As such, a reliable and safe quench detection mechanism is crucial for virtually all applications.

As shown in the FIGS. 1-3, the winding 12 is being formed as a tape element having a limited width dimension compared to its length dimension, said tape element 12 comprising a high-temperature superconducting, HTS, material. Examples of the HTS material can be at least one of the materials from the group consisting of (RE)BCO, BSCCO, TBCCO. But also other HTS materials can be used when composing the tape winding 12.

As depicted in FIG. 1a the first and second taps 13a-13b (first and second connection taps) are connected to the HTS tape winding exiting the plane of the coil at an angle. In the embodiment of FIG. 1a, the first and second connection taps 13a and 13b are connected to the HTS tape winding 12 at an angle α of 90°. FIG. 3 shown another embodiment wherein the first and second taps of the second type 14a and 14b are connected to the HTS tape winding 12 at an acute angle α between 30°-90°, in particular 70°-85°. Also the power taps 13a-13b can be likewise connected with the tape winding 12 under an acute angle α between 30°-90°, in particular 70°-85°. And likewise the taps of the second type 14a and 14b can be connected to the HTS tape winding 12 at an angle α of 90°.

The acute connection angle taps a of the several taps 13a-13b; 14a-14b with the HTS tape winding 12 allow for a proper exit of the taps from the winding 12 and ensures a proper, stable electrical connection. A stable electrical connection in terms of limited stress in the connection is ensured when the angle α of 90° is used.

As to the manufacturing to such electromagnetic coil assembly 10-10′, the tape winding 12 is wound on the bobbin or core 11, where during the winding process, one or more of the electrical taps 13a-13b; 14a-14b are connected at a desired a angle such that said taps can exit from the plane of the coil 12. Typically the angle α is 90°, such that only an axial component of the lead direction remains, though different angles may be beneficial for specific applications. As such, the several power taps 13a-13b and voltage taps 14a-14b are mechanical confined between the tape windings ensuring a proper and stable electrical connection.

Preferably the voltage taps 13a-13b are made from a superconducting material, and in an advantageous embodiment can be formed from as a tape shaped tap comprising a HTS material. More in particular the tape-shaped voltage taps 13a-13b are manufactured from the same HTS material as the HTS tape winding 12, e.g. at least one of the materials from the group consisting of (RE)BCO, BSCCO, TBCCO. But also other HTS materials can be used for the power taps 13a-13b and voltage taps 14a-14b. In another example the voltage taps 14a-14b can be manufactured from known cupper wires.

FIG. 1b depicts another detail of the embodiment of FIG. 1a and depicts the electrical connection of the power taps 13a and 13b from the coil 12 with power terminals of an external power circuit. For the sake of clarity only power tap 13b is shown as a HTS tape element of a limited short length exiting the plane of the coil 12 at an angle α of 90°. HTS tape element (electrical power tap) 13b (as well as its individual sub-taps 130b) is extended with an additional HTS tape element 13b′, which serves as an extension of the electrical power tap 13b (or sub-taps 130b) is electrically connected with its first element end 13b′-a with the HTS tape element 13b by means of an soldering connection 13z. The additional HTS tape element 13b′ is electrically connected with its other element end 13b′-b with a power terminal of an external power source (not shown).

Similarly (although not shown) also the other electrical power tap 13a shaped as a HTS tape element (as well as its individual sub-taps 130a) can be extended with such an additional HTS tape element 13a′ serving as an extension of the electrical power tap 13a (or sub-taps 130a) and electrically connected with its first element end 13a′-a with the HTS tape element 13a by means of an soldering connection 13z. The additional HTS tape element 13a′ is subsequently electrically connected with its other element end 13a′-b with the other power terminal of the external power source (not shown).

Seen from its position 13b′-a exiting the plane of the coil 12 till its connection 13b′-b to a power terminal of the external power circuit (not shown), each tape-shaped power tap 13a and 13b (shown as additional HTS tape element 13b′) exhibit a curvature, which curvature coincides with a field line of the magnetic field generated by the electromagnet coil assembly 10-10′ during operation. Herewith the exposure of the power taps 13a-13b to the magnetic field being generated creates a minimal disturbance and minimal exposure to electromagnetic (Lorentz) forces. In a similar fashion also the first power tap 13a (as well as its individual sub-taps 130a) can be extended with an additional HTS tape element 13a′ (not shown), which is electrically connected with its first element end 13a′-a with the HTS tape element 13a by means of an soldering connection 13z and with its other tape element end 13a′-b with the other power terminal of the external power source (not shown).

It is observed that both first and second power taps 13a-13b (as well as their individual sub-taps 130a-130b) can directly be formed as an elongated HTS tape element exiting the plane of the coil 12 and electrically connected with its free tape end (corresponding to tape element end 13a′-b or 13b′-b) with a power terminal of the external power source, thereby obviating the soldering connection 13z.

As depicted in FIGS. 1-3 the winding 12 consists of two winding sections, each denoted with 12a and 12b. Assuming that the plurality of turns of the complete coil or winding 12 consists of N turns, the first section 12a of the winding 12 consists of M turns, whereas the second section 12b consists of N minus M (N-M) turns. In view of this configuration of two winding sections 12a and 12b, the first power tap 13a is electrically connected with the first turn of the winding closest to the core 11. The second power tap 13b is electrically connected with turn M of the winding 12. Again, note that M<N. Both first and second power taps 13a-13b are electrically connected with the POSITIVE- and NEGATIVE-terminal of an external power source of the electromagnetic coil assembly 10-10′ for energizing the coil 12.

As to the second winding section 12b, the first voltage tap 14a type is electrically connected with turn M+1 of the second section 12b of the winding 12 and the second voltage tap 14b is electrically connected with turn O of the winding 12. Turn O of the winding 12 is located at the outer circumference side of the coil assembly, whereas the first turn (turn 1) is located at the core side 11 of the coil assembly. Preferably O≈N, in particular O═N.

As to a comparison of the number of windings of each winding section 12a and 12b the following formula can apply:

$$\frac{( N - M )}{N} « 1.$$

In particular:

$$0.01 « \frac{( N - M )}{N} « 0.1 .$$

For both formulas, N is the total amount of turns of the coil, whereas M is the number of turns between the first and second power taps 13a and 13b.

In particular the average winding tension of the turns 1 till M of said plurality of turns of the first winding section 12a is lower than the average winding tension of the turns M+1 till N of said plurality of turns of the second winding section 12b. In particular, when the turns M+1 till N of the second section 12b are applied with an average winding tension higher than the average higher winding tension of the turns 1 till M of the first winding section 12a, the inner winding section 12a of [1 . . . . M] turns of the winding are mechanically confined by the outer winding section 12b of [M+1 . . . . N] turns of the winding, also improving the mechanical stability of the coil.

The use of two windings sections 12a and 12b in a coil assembly is known as “overbanding”. However, in these embodiments 10 and 10′ of the electromagnetic coil assemblies, the “overbanding” consists of forming an additional winding section 12b radially around the first winding section 12a, i.e. the second winding section 12b forms a ring of (N-M) turns around the complete coil 12.

In an embodiment the winding of the second winding section 12b consist of the same HTS tape winding as that of the first winding section 12a. In another example another material is used, such as a metal tape having the same width dimension as the HTS tape winding 12 forming the first winding section 12a. In that particular example, the HTS tape winding is terminated after M turns with the second connection tap 13b and the winding continues with only a metal tape winding forming the second winding section 12b consisting of N-M turns. By continuing the winding after M turns past the position or connection of the second power tap 13b with a similar shaped tape winding (either the same HTS tape winding or a different metal tape winding) any free or lose ending winding part is avoided, which free or lose ending winding part would otherwise be exposed to the magnetic field being generated and might cause disturbances due to electromagnetic (Lorentz) forces.

In another example, the HTS tape winding continues from the first winding section 12a into the second winding section 12b.

As shown in FIGS. 2b-2c, the electromagnetic coil assembly 10′ comprises a third and fourth voltage tap 14c-14d, which are each connected with a turn of the coil within the first winding section 12a. Each third and fourth voltage tap 14c-14d can be electrically connected with the first and second power tab 13a-13b and hence with the first and M^{th} turn of the first winding section 12a as shown in FIG. 2b. Alternatively—as shown in FIG. 2c—each third and fourth voltage tap 13c-13d can be electrically connected with a turn of the first winding section 12a.

Additionally, each third and fourth voltage tap 14c-14d is electrically connected with a quench voltage detection system 20 using connecting wires 20a-20b. A quench voltage can be detected using the quench voltage detection system 20 between the third and fourth voltage taps 14c-14d. However, an electromagnetic coil assembly according to the invention can be implemented in contactless actuating systems and an actuator (carrier) passing the electromagnetic coil assembly will disturb the magnetic field generated by the coil. Such external disturbance or changes in the magnetic field will induce a current in the turns/windings of the first winding section 12a, which unfortunately may yield a false positive quench trigger.

Due to the winding configuration of two winding sections 12a and 12b, two concentric coils are created. By utilizing the additional windings M+1 till N forming the second winding section 12b, a zero voltage reading could be measured between the first and second voltage taps 14a-14b, when the coil assembly is powered by the external power source over the first and second power taps 13a-13b, even when no external disturbance of the magnetic field occurs. However, in the event of an external disturbance of the magnetic field, for example due to an actuator of an contactless actuation system passing the electromagnetic coil assembly, the external disturbance of the magnetic field will induce a current in the second winding section 12b, and an induced voltage difference across the voltage taps 14a and 14b between turns M+1 and O(N) will be measured using an additional voltage detection system 21 being connected to both first and second voltage taps 14a-14b using connecting wires 21a-21b.

By implementing the two further (third and fourth) voltage taps 14c-14d within the first winding section, for example electrically connecting the third voltage tap 14c near or with the first power tap 13a and electrically connecting the fourth voltage tap 14d near or with the second power tap 13b but at least with a turn <turn M), a quench or a loss of superconductivity resulting in a rapid rise of the Ohmic resistance within the first winding section 12a can be effectively detected by means of a voltage difference measured across both third and fourth voltage taps 14c-14d using a quench voltage detection system 20.

However, also an external disturbance of the magnetic field as outlined above will be detected by the third and fourth voltage taps 14c-14d, and as such cannot differentiate alone between an actual quench within the first winding section 12a of the coil 12 or an external disturbance of the magnetic field. Therefore, implementing also a quench voltage detection system 21 for the overbanding winding section 12b any voltage difference measured across the two voltage taps 14a-14b would directly correlate to external disturbances of the magnetic field. Thus, by performing differential voltage measurement over both the voltage taps 14c-14d and the two voltage taps 14a-14b, or more in particular of both winding sections 12a and 12b negates external influences and yields a more reliable quench-detection method.

### REFERENCE NUMERALS

10-10′ Embodiments of an electromagnet coil assembly
11 Core
12 Winding constituting the coil formed as a HTS tape
12a First group of plurality of turns [1; M]
12b Second group of plurality of turns [M+1; N]
13a First electrical power tap
13b Second electrical power tap
13b′ additional HTS tape element/extension of electrical power tap
13z soldering connection
14a First electrical voltage tap
14b Second electrical voltage tap
14c Third electrical voltage tap
14d Fourth electrical voltage tap
130a-130b Sub-taps of electrical taps
140a-140b Sub-taps of electrical taps

1. An electromagnet coil assembly comprising:
a core;
a winding constituting the coil being wound in a plurality of turns around said core; and
multiple power taps for electrically connecting the winding to an external power circuit, wherein
said winding is being formed as a tape element comprising a high-temperature superconducting, HTS, material,
the multiple power taps are connected to the HTS tape winding exiting the plane of the coil at an angle, and
said plurality of turns of said coil consists of N turns with a first power tap electrically connected with the first turn of the winding and a second power tap electrically connected with turn M of the winding, with M<N.

2. The electromagnet coil assembly according to claim 1, further comprising multiple voltage taps for measuring a voltage across at least part of said plurality of turns of the winding, wherein a first voltage tap is electrically connected with turn M+1 of the winding and a second voltage tap is electrically connected with turn O of the winding, with O≈N, in particular O═N.

3. The electromagnet coil assembly according to claim 1, wherein the power taps are made from a superconducting material.

4. The electromagnet coil assembly according to claim 3, wherein the power taps are formed as tape shaped power taps comprising a high-temperature superconducting, HTS, material.

5. The electromagnet coil assembly according to claim 1, wherein the power taps are connected to the HTS tape winding at an angle α between 30°-90°, in particular at an angle α of 90°.

6. The electromagnet coil assembly according to claim 1, wherein the power taps—seen from their position exiting the plane of the coil till their connection to a power terminal of the external power circuit—exhibit a curvature which curvature coincides with a field line of the magnetic field generated by the electromagnet coil assembly during operation.

7. The electromagnet coil assembly according to claim 1, with:
$$\frac{( N - M )}{N} « 1.$$

8. The electromagnet coil assembly according to claim 7, with:
$$0.01 « \frac{( N - M )}{N} « 0.1 .$$

9. The electromagnet coil assembly according to claim 1, wherein the average winding tension of the turns 1 till M of said plurality of turns is lower than the average winding tension of the turns M+1 till N of said plurality of turns.

10. The electromagnet coil assembly according to claim 1, wherein the core is a ferromagnetic core.

11. The electromagnet coil assembly according to claim 1, wherein at least each power tap comprises multiple sub-taps.

12. The electromagnet coil assembly according to claim 1, wherein the HTS material is at least one of the materials from the group consisting of (RE)BCO, BSCCO, TBCCO.
